(19) United States
(12) Patent Application Publication
(10) Pub. No.: US 2006/0284025 A1
(43) Pub. Date: Dec. 21, 2006

(54) Conduit spacer

(75) Inventor: Mark J. Faucher, San Diego, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(73) Assignee: FOSHAY ELECTRIC CO., INC.

(21) Appl. No.: 11/143,122

(22) Filed: Jun. 1, 2005

(51) Int. Cl. E21F 17/02; F16L 5/00

(52) U.S. Cl. 248/58; 285/136.1

(57) ABSTRACT

The present invention provides a conduit for locating a conduit within a foundation, the conduit spacer comprising a substantially planar piece of sheet metal having an aperture dimensioned to receive the conduit. The substantially planar piece of sheet metal comprises a permanent portion and a disposable portion that are separated by a line of demarcation that is substantially disposed along an edge of the foundation, wherein the disposable portion may be detached from permanent portion without the use of tools.

### FIELD OF THE INVENTION

The present invention is directed to conduit spacers, and more particularly to conduit spacers for structural foundations that facilitate the proper placement of conduits within the foundation.

### BACKGROUND OF THE INVENTION

During the pouring of foundations (e.g., for public, residential and business structures), it is conventional to provide conduits (e.g., pipes) that are disposed through the foundation, thereby allowing the subsequent running of cables, wires, fluid pipes and other lines through the conduits.

For electrical wires, cable television lines and telephones lines, it is frequently desirable that each pipe is located within the foundation such that the pipe is disposed between interior and exterior walls of the structure. If the pipe is disposed too close to the form board, there is not enough room to provide enough cement between the pipe and the form board. This situation may result in an imperfection in the foundation that is visually undesirable, and may further result in a defect that renders the foundation structurally unsound. Post pour repair work is frequently needed to correct such defects.

U.S. Pat. No. 5,125,619 discloses a pipe support element for supporting a pipe during a concrete pouring operation, the pipe support element comprising a monolithic, one-piece body including a C-shaped section that abuttingly engages a pipe, and a wire support strap that is wrapped around the pipe and secured using a nail. The pipe support element is attached to a form board prior to pouring concrete, and is removed for re-use after the concrete sets. One drawback of the pipe support element is that it may be difficult to detach the pipe support element from the form board after the concrete sets. A further drawback is that the pipe support element may contain sharp edges that can cause injuries while being detached. An additional drawback is that the pipe support element is likely to become bent or otherwise damaged during use and/or detachment, and therefore become unsuitable for re-use.

In view of the above, there exists a need for a conduit spacer for a structural foundation that facilitates the proper placement of a conduit within a foundation.

There further exists a need for a conduit spacer for a structural foundation that does not require the use of tools to detach after use.

There also exists a need for a conduit spacer for a structural foundation that is partially removed after use.

There further exists a need for a conduit spacer for a structural foundation that reduces the risk of injury during use.

There also exists a need for a conduit spacer for a structural foundation that includes a protruding portion that is removed after use.

### SUMMARY OF THE INVENTION

In view of the foregoing, it is an object of the present invention to provide a conduit spacer for a structural foundation that facilitates the proper placement of a conduit within a foundation.

It is a further object of the invention to provide a conduit spacer for a structural foundation that does not require the use of tools to detach after use.

It is another object of the invention to provide a conduit spacer for a structural foundation that is partially removed after use.

It is a further object of the invention to provide a conduit spacer that reduces the risk of injury during use.

It is an additional object of the invention to provide a conduit spacer for a structural foundation that includes a protruding disposable portion that is removed after use.

One aspect of the present invention involves a conduit for locating a conduit within a foundation, the conduit spacer comprising a substantially planar piece of material, like sheet metal, having an aperture dimensioned to receive the conduit. The substantially planar piece of material comprises a permanent portion and a disposable portion that are separated by a line of demarcation that is substantially disposed along an edge of the foundation, wherein the disposable portion may be detached from permanent portion without the use of tools. The line of demarcation may comprise a perforation line, a line of reduced spacer thickness or a weak zone that separates the disposable and permanent portions.

The disposable portion includes a base edge that is approximately parallel to the line of demarcation. In a preferred embodiment of the invention, the aperture is disposed at a predetermined distance from the base edge to facilitate the proper placement of the conduit within the foundation. Alternatively, the aperture may be disposed at a predetermined distance from the line of demarcation to facilitate the proper placement of the conduit within the foundation. According to further embodiments of the invention, the conduit spacer may include one or more additional apertures for receiving additional conduits.

Another aspect of the invention involves a system for retaining a conduit at a predetermined distance from a board, the system comprising a pair of conduit spacers. Each conduit spacer comprises a substantially planar piece of sheet metal having a permanent portion and a disposable portion that are separated by a line of demarcation, and an aperture disposed in the permanent portion for receiving the conduit. The disposable portion may be detached from the conduit spacer along the line of demarcation without the use of tools. Each line of demarcation comprises a perforation line, a line of reduced spacer thickness or a weak zone that separates the disposable and permanent portions. According to further embodiments of the invention, each conduit spacer further comprises one or more additional apertures for receiving additional conduits.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a side view of a preferred conduit spacer for locating a conduit within a foundation of a structure, in accordance with the principles of the present invention;

FIG. 2 is a side view of an alternative conduit spacer for locating a conduit within a foundation of a structure;

FIG. 3 is a side view of the conduit spacer of FIG. 1 attached to a form board;

FIG. 4 is a cross-sectional view of a preferred system for retaining a conduit at a predetermined distance from a form board, in accordance with the principles of the present invention;

FIG. 5 is a cross-sectional view of the system of FIG. 4 after the form board has been removed from the foundation;

FIG. 6 is a side view of the conduit spacer of FIG. 2 attached to a form board; and

FIG. 7 is a perspective view of a system for retaining multiple conduits at a predetermined distance from a form board, in accordance with the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides conduit spacers for structural foundations that facilitate the proper placement of a conduit within a foundation. The conduit spacers preferably do not require the use of tools to detach after use. Particularly, a disposable protruding portion of the conduit spacer is removed after use by breaking off the protruding portion from the conduit spacer along a line of demarcation.

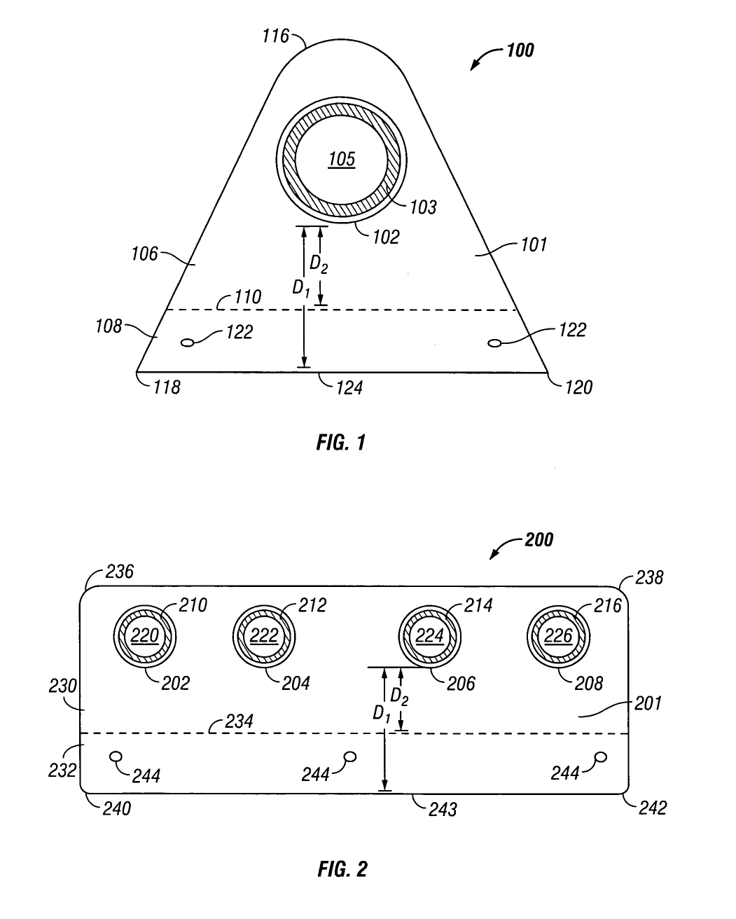

Referring to FIG. 1, a preferred conduit spacer 100 for locating a conduit 103 within a foundation of a structure comprises a single conduit spacer having aperture 102 dimensioned for receiving a conduit 103. Conduit spacer 100 preferably comprises a substantially planar piece of sheet metal 101, whereas conduit 103 comprises a predetermined length of pipe or other tubing having a central opening 105 dimensioned for the passage of cables, wires, fluid pipes and other lines. Other planar materials like plastic could also be used. Conduit spacer 100 comprises permanent portion 106 and disposable portion 108 that are separated by a line of demarcation 110.

In operation, the spacer 100 is positioned such that the line of demarcation 110 is designed to be substantially disposed along the edge of the foundation such that the protruding disposable portion 108 may be detached from permanent portion 106 without the use of tools. Line of demarcation 110 may comprise a visible mark, a perforation line, a line of reduced spacer thickness or a weak zone that separates the disposable and permanent portions. After the foundation material has hardened sufficiently, a worker may break off the protruding disposable portion by merely bending the spacer back and forth along the line of demarcation until the spacer breaks along the line due to fatigue.

In the illustrated embodiment, conduit spacer 100 is a substantially triangular piece of sheet metal 101, wherein the corner 116 adjacent to aperture 102 is rounded to reduce the incident of workers being cut. Corners 118, 120 are part of disposable portion 108, which includes one or more holes 122 for receiving nails or other fasteners for mounting the spacer to a form board. Aperture 102 is depicted as a relatively large aperture dimensioned to receive a proportionately large conduit 103. As would be understood by those of ordinary skill in the art, conduit spacer 100 may be other shapes (e.g., substantially rectangular or substantially circular), and aperture 102 may be other sizes (e.g., sized to fit a smaller conduit), without departing from the scope of the invention. Furthermore, conduit spacer 100 may include additional apertures for receiving additional conduits.

With further reference to FIG. 1, disposable portion 108 of conduit spacer 100 includes a base edge 124 that is approximately parallel to the line of demarcation. Aperture 102 is disposed at a predetermined distance D₁ from base edge 124, or is disposed at a predetermined distance D₂ from line of demarcation 110. The proper placement of conduit 103 within the foundation may be achieved by locating aperture 102 with respect to base edge 124 or with respect to line of demarcation 110. Improper placement of the conduit may result in an imperfection in the foundation and/or a defect that renders the foundation structurally unsound. Advantageously, the conduit spacers of the present invention facilitate the proper placements of conduits within a foundation such that post pour repair work is not needed to correct such imperfections and defects.

Referring to FIG. 2, conduit spacer 200 comprises a multiple conduit spacer for locating conduits 202, 204, 206, 208 within a foundation of a structure. Multiple conduit spacer comprises a substantially planar piece of sheet metal 201 having apertures 202, 204, 206, 208 dimensioned to receive conduits 210, 212, 214, 216, respectfully. Conduits 210, 212, 214, 216 comprise predetermined lengths of pipe or other tubing having central openings 220, 222, 224, 226 for the passage of lines such as cables, wires and fluid pipes.

Similar to the previous conduit spacer embodiment, conduit spacer 200 includes a permanent portion 230 and a protruding disposable portion 232 separated by a line of demarcation 234 that is designed to be substantially disposed along the edge of the foundation. The line of demarcation may comprise a perforation line, a line of reduced conduit spacer thickness or a weak zone that allows the disposable and permanent portions to be separated by hand without the use of tools.

In the embodiment depicted in FIG. 2, conduit spacer 200 is substantially rectangular. The conduit spacer includes rounded corners 236, 238 located on the permanent portion 230 and corners 240, 242 located on protruding disposable portion 232. Disposable portion 232 includes base edge 243 and one or more nail holes 244 for receiving nails or other fasteners for mounting the spacer to a form board. Each aperture 202, 204, 206, 208 is disposed at a predetermined distance D₁ from base edge 243 or at a predetermined distance D₂ from line of demarcation 234. As would be understood by those of ordinary skill in the art, apertures 202, 204, 206, 208 may be other sizes (e.g., dimensioned to fit smaller and/or larger conduits), without departing from the scope of the invention. Furthermore, apertures may be different sizes to fit conduits having varying sizes.

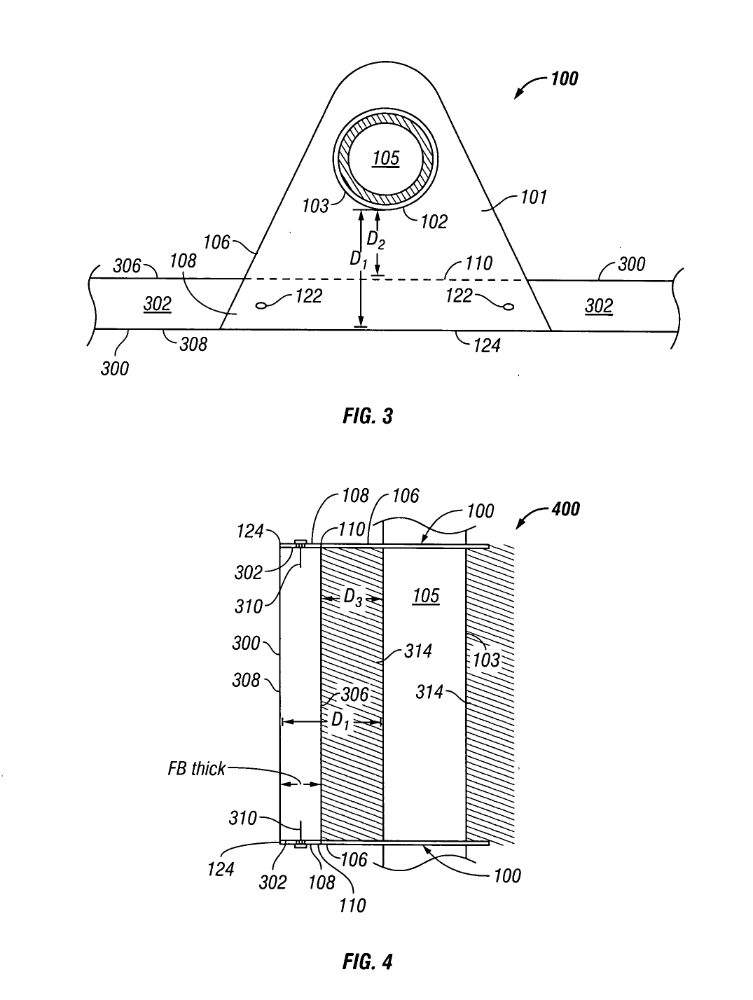

Referring to FIG. 3, conduit spacer 100 for locating conduit 103 within a foundation is shown mounted to an edge 302 of form board 300. Specifically, disposable portion 108 is attached to form board edge 302 using fasteners such as nails that pass through holes 122 and into the form board. Aperture 102 is disposed at a predetermined distance D₁ from base edge 124, or is disposed at a predetermined distance D₂ from line of demarcation 110. Form board 300 comprises an interior side 306 and an exterior side 308, wherein foundation material such as cement is poured on the interior side of the form board. After the foundation material has hardened sufficiently, the form board is removed and disposable portion 108 is broken off of the spacer 100 along the line of demarcation 110 and discarded. Alternatively, disposable portion may be ground off or cut off along the line of demarcation 110.

Referring to FIG. 4, in accordance with the principles of the present invention, a preferred system 400 for retaining a conduit 103 at a predetermined distance D₃ from a form board 300 comprises a pair of conduit spacers 100. With reference to FIGS. 3 and 4, predetermined distance D₃ is the distance between aperture 102 and line of demarcation 110, such that D₃=D₂. Also, D₃=D₁−FB_{thick}, wherein FB_{thick} is the thickness of the board. Proper placement of conduit 103 within the foundation is thus achieved by locating apertures 102 at predetermined distance D₁ from base edge 124 or at predetermined distance D₂ from line of demarcation 110.

Disposable portions 108 of conduit spacers 100 are attached to edges 302 of form board 300 by passing nails 310 or other fasteners through holes 122 and into form board 300. The conduit spacers preferably are attached to the form board such that base edges 124 are substantially flush with exterior side 308 of form board 300. Foundation material 314 such as cement is poured on the interior side 306 of the form board and allowed to harden.

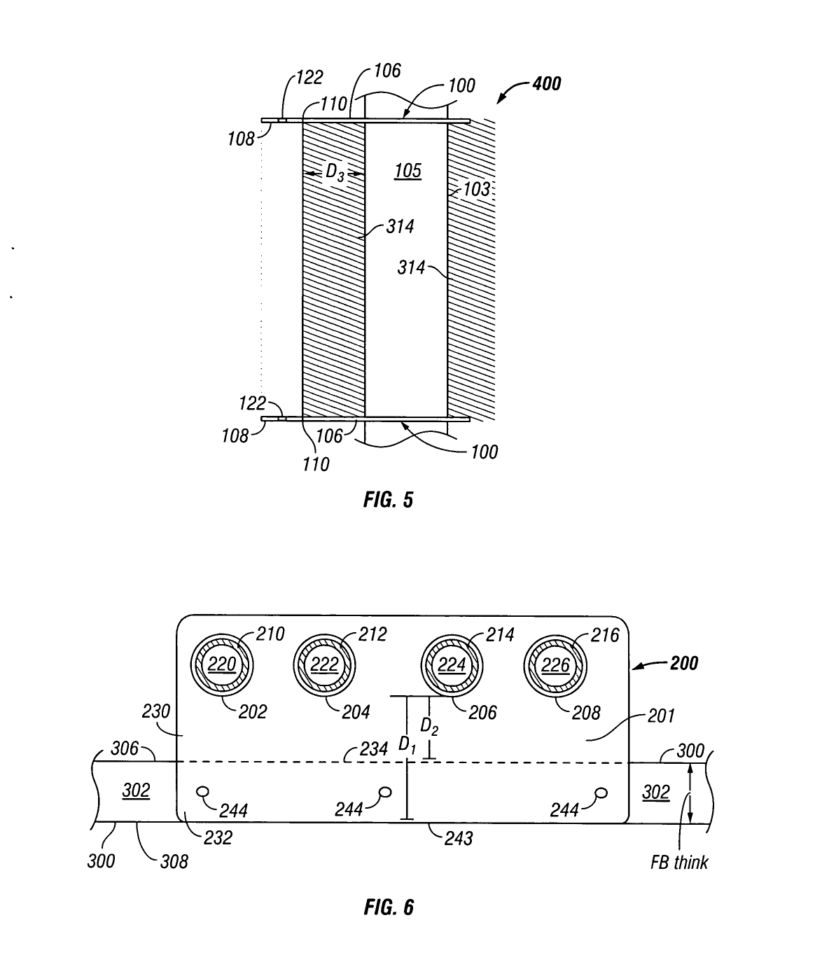

Referring to FIG. 5, once the foundation material 314 has been allowed enough time to harden and set properly, the form boards are removed from the foundation 314 such that disposable portions 108 protrude from the edge of foundation 314. Protruding disposable portions 108 preferably are broken off of spacers 100 along lines of demarcation 110 that is substantially disposed along the edge of foundation 314. The lines of demarcation 110 are perforation lines or lines of reduced spacer thickness that, advantageously, allow workers to merely bend the protruding disposable portions along the lines of demarcation until the protruding disposable portions 108 break away. Alternatively, the protruding portions 108 may be cut off or ground away such that the conduit spacer is substantially flush with the exterior edge of foundation 314.

Referring to FIG. 6, conduit spacer 200 for locating conduits 210, 212, 214, 216 within a foundation is shown mounted to an edge 302 of form board 300. Specifically, disposable portion 232 is attached to form board edge 302 using fasteners that pass through holes 244 and into the form board. In operation, foundation material such as cement is poured on interior side 306 of form board 300 and allowed sufficient time to properly harden. Thereafter, the form board is removed and disposable portion 232 is broken off of the spacer 200 along the line of demarcation 234 and discarded. According to other embodiments, disposable portion 232 may be ground off or cut off along the line of demarcation 234.

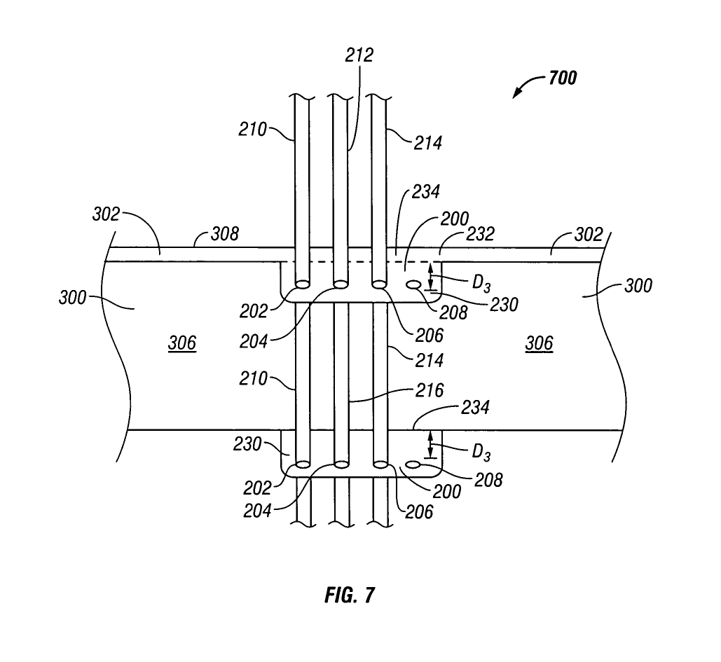

Referring to FIG. 7, a system 700 for retaining conduits 210, 212, 214 at a predetermined distance D₃ from a form board 300 comprises a pair of multiple conduit spacers 200. With reference to FIGS. 6 and 7, predetermined distance D₃ is the distance between apertures 202, 204, 206, 208 and line of demarcation 234, such that D₃=D₂. Also, D₃=D₁−FB_{thick}, wherein FB_{thick} is the thickness of the board. Proper placement of conduit 103 within the foundation is thereby achieved by locating apertures 202, 204, 206, 208 at predetermined distance D₁ from base edge 243 or at predetermined distance D₂ from line of demarcation 234.

After the conduit spacers are attached to the form board, the foundation material is poured on the interior side 306 of the form board and allowed to harden. Thereafter, the form boards are removed from the foundation such that disposable portions 232 protrude from the edge of the foundation. Protruding disposable portions 232 are detached along lines of demarcation 234 along the edge of the foundation. According to other embodiments of the invention, the protruding portions 232 may be cut off or ground away such that the conduit spacer is substantially flush with the exterior edge of the foundation.

Thus, it is seen that a conduit spacer for use during the construction of a foundation is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A conduit spacer for locating a conduit within a foundation, the conduit spacer comprising:
a substantially planar member having an aperture dimensioned to receive the conduit;
wherein the substantially planar member comprises a permanent portion and a disposable portion that are separated by a line of demarcation.

2. The conduit spacer of claim 1, wherein the disposable portion may be detached from permanent portion without the use of tools.

3. The conduit spacer of claim 1, wherein the line of demarcation is positioned on the spacer such that the line, where the spacer is in use, is substantially disposed along an edge of the foundation.

4. The conduit spacer of claim 1, wherein the line of demarcation comprises a perforation line that separates the disposable and permanent portions.

5. The conduit spacer of claim 1, wherein the line of demarcation comprises a line of reduced spacer thickness or a weak zone that separates the disposable and permanent portions.

6. The conduit spacer of claim 1, wherein the disposable and permanent portions are detachable from each other along the line of demarcation.

7. The conduit spacer of claim 1, wherein the disposable portion includes one or more holes for mounting the spacer to a form board.

8. The conduit spacer of claim 1, further comprising one or more additional apertures for receiving additional conduits.

9. The conduit spacer of claim 1, wherein the disposable portion includes a base edge, wherein the aperture is disposed at a predetermined distance from the base edge to facilitate the proper placement of the conduit within the foundation.

10. The conduit spacer of claim 1, wherein the aperture is disposed at a predetermined distance from the line of demarcation to facilitate the proper placement of the conduit within the foundation.

11. A system for retaining a conduit at a predetermined distance from a board, the system comprising a pair of conduit spacers, wherein each conduit spacer comprises:
a substantially planar piece of material having a permanent portion and a disposable portion that are separated by a line of demarcation, and an aperture disposed in the permanent portion for receiving the conduit;
wherein the disposable portion is detachable from the conduit spacer along the line of demarcation.

12. The system of claim 11, wherein the predetermined distance is substantially equivalent to a distance between the aperture and the line of demarcation.

13. The system of claim 11, wherein each disposable portion may be detached from the conduit spacer without the use of tools.

14. The conduit spacer of claim 11, wherein each line of demarcation comprises a perforation line that separates the disposable and permanent portions.

15. The conduit spacer of claim 11, wherein each line of demarcation comprises a line of reduced spacer thickness or a weak zone that separates the disposable and permanent portions.

16. The conduit spacer of claim 11, wherein each disposable portion includes one or more holes for mounting the spacer to the board.

17. The conduit spacer of claim 11, wherein each conduit spacer further comprises one or more additional apertures for receiving additional conduits.

18. The conduit spacer of claim 11, wherein the disposable portion includes a base edge, wherein the aperture is disposed at a predetermined distance from the base edge to facilitate the proper placement of the conduit within a foundation.

19. The conduit spacer of claim 11, wherein the aperture is disposed at a predetermined distance from the line of demarcation to facilitate the proper placement of the conduit within a foundation.

20. A conduit spacer for locating a conduit within a foundation, the conduit spacer comprising:
a substantially planar plate having an aperture dimensioned to receive the conduit;
wherein the substantially planar plate comprises a permanent portion and a disposable portion that are separated by a line of demarcation that is substantially disposed along an edge of the foundation;
wherein the disposable portion may be detached from permanent portion without the use of tools.
